(19) United States
(12) Patent Application Publication
(10) Pub. No.: US 2008/0023543 A1
(43) Pub. Date: Jan. 31, 2008

(54) Personal Verification System

(76) Inventor: Arthur A. Beisang, White Bear Lake, MN (US)

Correspondence Address: C. G. Mersereau, Esq.;NIKOLAI & MERSEREAU, P.A., Suite 820, 900 Second Avenue South, Minneapolis, MN, 55402-3813, US

(21) Appl. No.: 11/538,097

(22) Filed: Oct. 3, 2006

Related U.S. Application Data
(60) Provisional application No. 60/820,294, filed on Jul. 25, 2006.

(51) Int. Cl. G06K 5/00

(52) U.S. Cl. 235/382; 235/380

(57) ABSTRACT

The present invention relates generally to a highly reliable personal verification system and associated method and device for recording biometric data and identifying and monitoring individuals as part of groups sought to be monitored. The system and method for identifying individuals is based on an individual's communicated biometric data selected from (among others) photo, fingerprint and voice print data to achieve a desired level of positive identification. An individual's location can also be verified and communication established with a second population of persons or agencies authorized to access identification verification. The system is particularly useful for identifying and monitoring aliens admitted to a country on visas.

### CROSS REFERENCE

This application claims the benefit of Application No. 60/820,294 filed on Jul. 25, 2006.

### BACKGROUND OF THE INVENTION

I. Field of the Invention

The present invention relates generally to a highly reliable personal verification system for recording biometric data and identifying and monitoring individuals which are identified as members of groups sought to be monitored. More particularly, the invention is directed to a system and method for identifying individuals based on communicated biometric data selected, for example, from photo, fingerprint and voice print sent by individuals using portable electronic communication devices. The data is of sufficient accuracy to achieve a desired level of positive identification. The location of the portable electronic communication devices can also be verified. Communication can also be established with a second population of devices related to persons or agencies authorized to access an identification verification data bank. The system is particularly useful for identifying and keeping track of aliens admitted on visas.

II. Related Art

Approximately 12 million immigrants come to the United States each year on visas. It is well known that the United States visa system, as presently administered, presents a very inaccurate and inefficient effort for keeping track of immigrants and others admitted in the United States on visas. Because of the large influx of illegal aliens, and the present tracking inefficiencies of this visa system, the President of the United States has recently called for the design of a tamper-proof biometric identification card for immigrants in this country on visas. Congress is also currently proposing legislation to admit an additional 2 million Mexican immigrants each year on temporary work visas. In addition, American companies that hire illegal immigrants are currently facing the possibility of a $40,000 fine per incident, should they be prosecuted, for hiring illegal aliens. Thus, both the U.S. government and U.S. employers would find an efficient system for positively identifying and monitoring legal immigrants with U.S. government visas very desirable. A common need also exists with regard to other groups or populations such as persons serving home sentences and those on probation, for example.

### SUMMARY OF THE INVENTION

By means of the present invention, there is provided a simple and accurate system for identifying and keeping track of individual members of a specified population of individuals such as legal immigrants in this country on government visas. Such a group of interest may be referred to or defined as a “first population”. The system includes one or more central processors or entities for communicating with members of a first population, collecting, storing, comparing and evaluating biometric data received at selection intervals from each individual in a first population of interest. As used herein the term “central processor” means any entity capable of performing the above described functions. Each individual is provided with a portable electronic communication device, such as a dedicated or limited use cellular phone, pager, or the like for communicating with central processors. Each portable electronic communication device is configured to sense and transmit biometric data selected from photo, fingerprint and voice print data to one or more central processors in sufficient detail to enable the system to achieve a desired average level of positive identification confirmation of individuals by a central processor. A global position sensor (GPS) system may also be provided to pinpoint the location of the individual transmitting communication device.

In this manner, in one embodiment, each immigrant granted a visa, for example, is supplied with a cellular phone or similar communication device by the U.S. Immigration Service upon arrival and admission to this country. The device is first used to gather and establish initial identifying biometric data including photo, fingerprint and possibly voice print data from the individual and this is transmitted to a central processor computer and stored in a data bank, possible one utilized by the United States Department of State which has issued the initial visa with known limitations to the visa holder which would also be communicated. As indicated, the biometric data that the visa phone is capable of sensing and transmitting is made sufficiently detailed so that the average level of positive identification sought to be achieved by the issuing bureau is met. This may be a portrait and two fingerprints, or additional fingerprints, or even a voice print in addition to the other data depending on the desired reliability factor.

The visa holder is instructed as how to take his/her fingerprints and how to take his/her portrait and voice print and also how to send that data into the central processor via the visa phone or other portable electronic communication device. The data will be encrypted to that individual by the portable electronic communication device and/or central processor to limit access to selected approved inquirers.

During the stay of the visa holder in the United States, he or she is periodically requested to send biometric identification data of a desired level selected from portraits, fingerprints and voice prints into a selected U.S. Government processing site to be automatically compared with earlier data by the U.S. Government central processor which notes that the particular individual has reported in and is successfully being tracked or monitored and accounted for.

Other groups or “second” populations which have a valid and vital interest in the positive identification of an immigrant as being legally in the country, or a member of another group or first population of interest which needs to be tracked, including prospective employers, law enforcement agencies, licensing bureaus, welfare agencies and others can also be given devices and access codes which enable them to access and communicate with a central processor which shares a database with a Government computer, or the like, in order to verify the identification of prospective employees, those seeking driver's licenses, education services, etc.

In this manner, the individual visa holder or other group member with a communication device can also demonstrate his/her identity at will, with official government approval, to anyone which that member desires to identify him/herself.

It will be appreciated that a first receiving central entity or processor may thus share data with other selected separate central processing sites such that each site may be dedicated to particular task with respect to conforming identification to an accessing group having a “need to know” and monitoring of separate aspects affecting the visa holder or individual in another segment of the population sought to be identified and monitored. In this manner, one central processor can be used to gather initial data and track periodic reporting data a visa holder sends to the Government, another can be used for checking a visa holder's identification by prospective employers and others might include access by motor vehicle departments, etc. It will also be appreciated that such separate processors could communicate with each other to the extent necessary to provide a composite database regarding each individual communication device holder.

Thus, according to an aspect of the invention, the prospective employers, law enforcement departments, license bureaus and other agencies and groups having a valid “need to know” can be seen as members of a group collectively defined as a “second population” given the ability to access and communicate with one or more central processor databases to verify the identity and/or location of individual members of a selected first population.

### BRIEF DESCRIPTION OF THE DRAWINGS

In the drawings wherein like numerals designate like parts throughout the same:

FIG. 1a is a block diagram showing selected components of a typical portable electronic communication device suitable for use by individuals in a first population sought to be monitored;

FIG. 1b depicts in schematic form a device that incorporates the components of FIG. 1a in the form of a limited use cellular phone; and

FIGS. 2a-2d show a series of flow charts illustrating aspects and options of the verification system of the invention.

### DETAILED DESCRIPTION

The detailed description that follows is presented as an example of an embodiment of a broader inventive concept and is not intended to define or limit the scope of the invention. It will be recognized that modifications may occur to those skilled in the art which are clearly within the confines of the inventive concept.

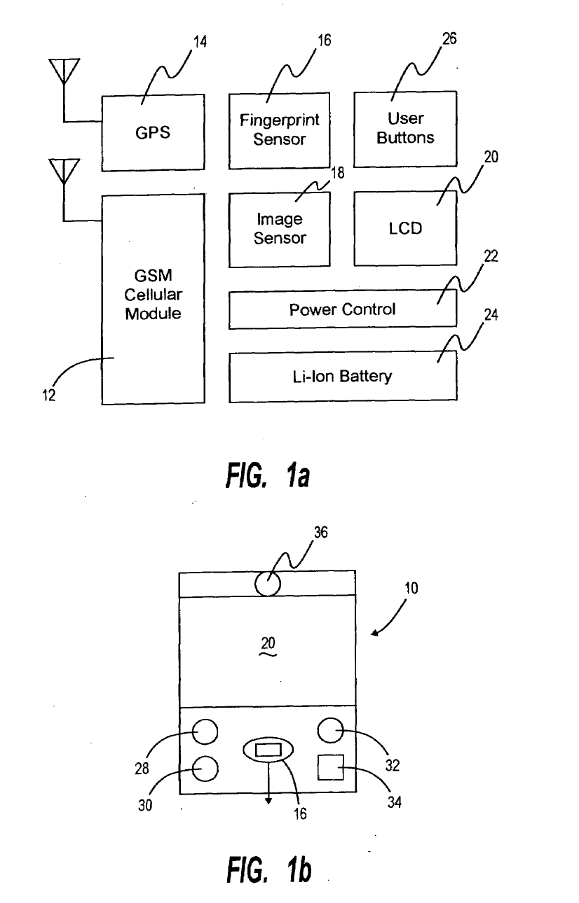

In the drawings, FIG. 1a depicts in block form certain selected modules or components incorporated in a portable electric communication device of a class suitable for use by individuals in a first population sought to be overseen using the system of the present invention. FIG. 1b is a schematic representation of a typical embodiment of a communication device incorporating components as in FIG. 1a. The portable electronic communication device which is shown generally at 10, provides two-way communication between an individual associated with the device and one or more remote central processing units which collect, store and compare biometric data for identification and tracking purposes.

The electronic communication device illustrated at 10 is in the form of a dedicated cellular phone of limited use which incorporates a combination of sensing devices. As seen at 12, the communication device is designed to work on a global system for mobile (GSM) cellular network using a GSM module which may be of an encrypted type such as are available from Wavecom of San Diego, Calif. An integrated global position sensor (GPS) module is also included at 14. Such systems are commercially available which have excellent indoor and/or outdoor performance with any desired degree of accuracy. One supplier is eRide Corporation of San Francisco, Calif. The communication device further includes a fingerprint sensor 16 which has the necessary technology to perform a fast and reliable scan and which is only minimally affected by cuts or burns on the surface of the fingers being scanned. Such sensors are available from sources such as Authen Tec, Inc. of San Jose, Calif. A camera system is provided which includes an image sensor 18 which provides the necessary high level of detail to facilitate repeatable recognition using known facial recognition algorithms together and may also be provided with available anti-jitter technologies to minimize blurred images. Such image sensing modules are available from Micron Technologies, Inc. of Boise, Id. Other components include an LCD display 20, power control 22, a rechargeable battery 24 such as a lithium ion battery and a variety of user buttons at 26.

The schematic representation of the cellular phone at 10 in FIG. 1b, includes a variety of user buttons from the block 26 of FIG. 1a, including but not limited to, a send button 28, end button 30 and on/off button 32. A button for operating the image sensor shutter is shown at 34 and the camera lens at 36. It will be appreciated that the communication device may take other forms and include other combinations or modules.

All functions can be made sufficiently high definition to enable very accurate identification results using known recognition algorithms. Thus fingerprint matching, for example has been demonstrated by the National Institute of Standards in Denver, Colo. to have less than 0.2% recognition error. Using a combination of several types of biometric data reduces the recognition error much further.

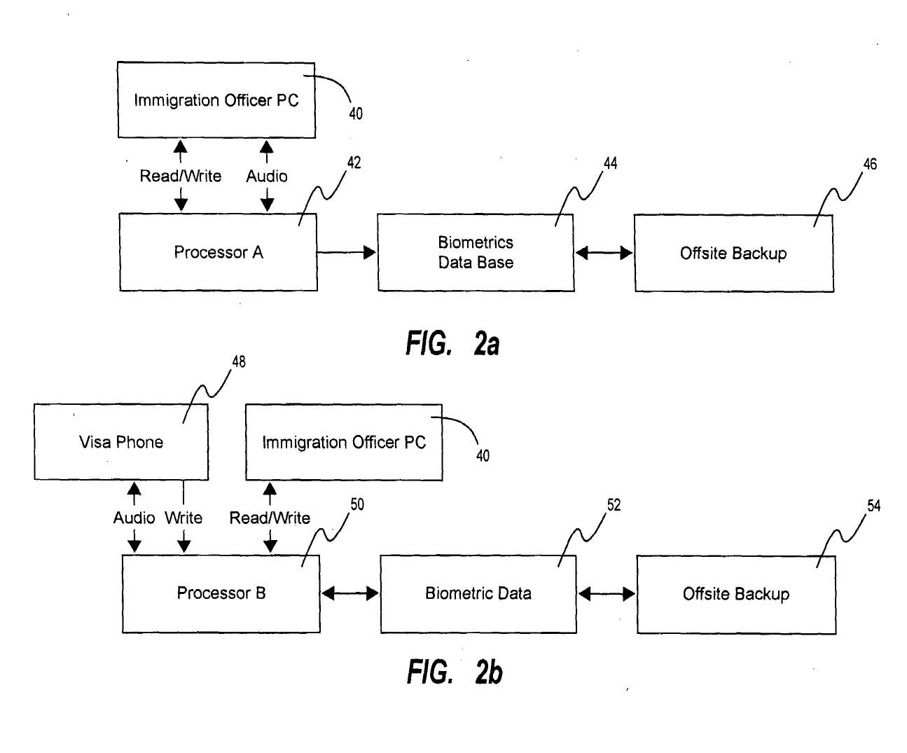

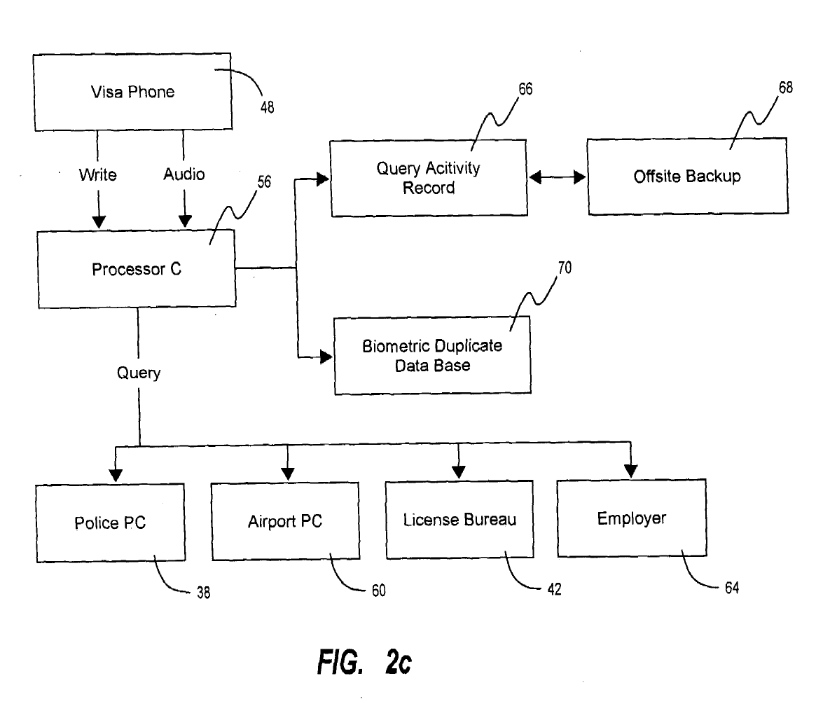

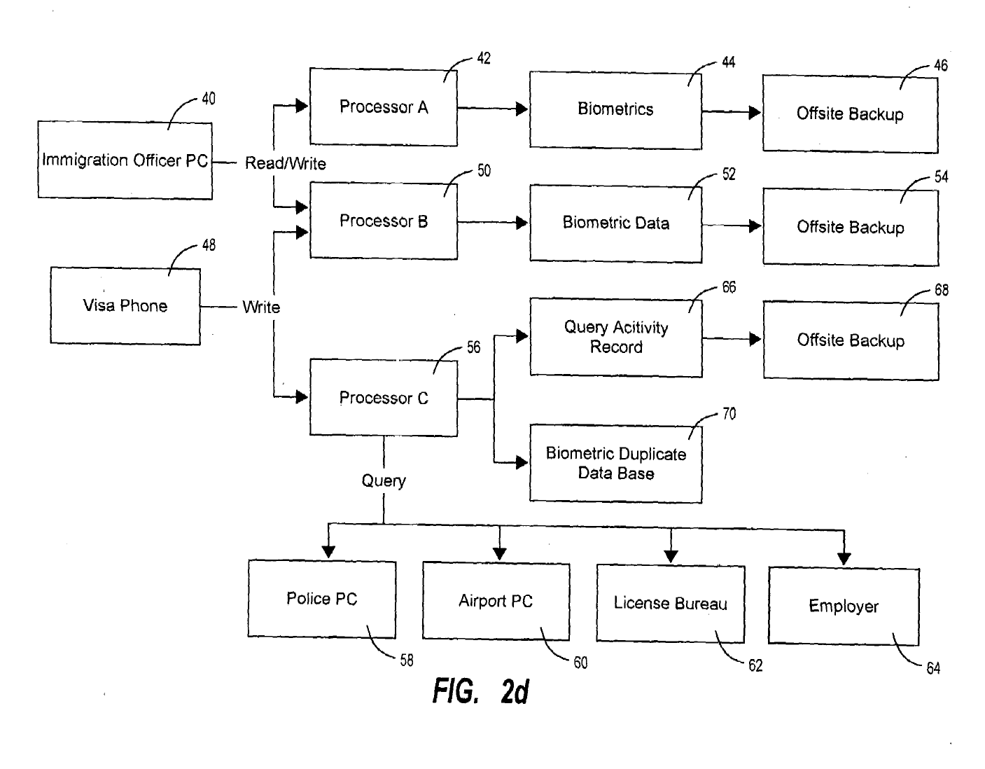

As seen in FIG. 2a, for example, an immigration officer from the Immigration and Naturalization Service at 40 would have the ability to communicate with a central processor 42 which, in turn, would be able to access the biometric data of the members of an entire first population of those issued visas and related portable electronic communication devices. The biometric data bank represented by 44 includes initial data received at the time the portable electronic communication device is issued to the visa holder and this includes an offsite backup for the data at 46. Individual data is keyed to the device of origin by encrypted code which assures its integrity.

As shown in FIG. 2b, the portable electronic communication device issued to a visa holder, or visa phone, is shown at 48 with the ability to communicate with a second central processor B at 50. In addition to being able to communicate written data, the visa phone can also be equipped to communicate audio voice prints to the processor B at 50. This would include periodic updating data received from the visa holder at designated intervals. This results in another bank of biometric data storage at 52 to offsite backup 54.

FIG. 2c adds a third processor function, processor C, at 36 in which biometric data from the visa holder via his electronic communicating visa phone at 58 can be used for verification of identity to various other functioning entities as indicated at 58, 60, 62 and 64. In this case, both the recent activity record as at 66, offsite backup and comparative biometric data at 70 can be queried to retrieve information relative to the holder of the visa phone 48 and communicated to other entities given access to the system. It should be noted that each of the illustrated entities also given access including police, airports, license bureaus and employers have previously been cleared or justified and given encrypted access codes.

FIG. 2d illustrates a possible embodiment of an entire system, possibly in its simplest form and represents an integration of FIGS. 2a-2c. Thus, it can be seen that a plurality of separate processing sites can be established to share data transmitted by each portable electronic communication device. In this manner, one or more additional processors can be used for checking a device carrier or visa holder's identification by employers, motor vehicle departments, law enforcement and other people who have been enabled to access this system and who the user of the portable electronic communication device (member of a first population) desires to establish the validity of his identification. The other processor can then be used for storing periodic reporting data should this be required. In the case of immigrants making up the first population, the third or primary processor as at 42 in FIG. 2a, would be used by the United States State Department and run by immigration officers for the initial enrollment of visa holders and the initial biometric data. The data from all processors, as necessary, can be duplicated and backed up in a manner well known in the art.

Thus, in operation, a personal portable electronic communication device in the form of a cell phone would be issued to each visa holder by a U.S. immigration officer at the point of entry in the U.S. where the immigrant typically receives a visa. The visa holder would then be instructed in the use of the phone and required to send his/her biometric identification data updated by additional sets of data periodically by the visa cell phone to a data recording computer system maintained by the U.S. government. As previously described, the cell phone or other wireless electronic communication device has the necessary image resolution to record the level of fingerprint and portrait data necessary to give the required degree of accuracy for the verification system based on known recognition algorithms.

Each communication device is programmed to communicate using a desired encryption level to the relevant processors including GSM security encryption. The visa holder or other group member can have the connected processor verify his/her identification by using his/her communication device. This provides positive identification or denial of the visa holder in real time to anyone connected having a need to know. Those having access to the data can be advised by return e-mail of the match or lack of match regarding the relevant person's identity check.

Whereas an embodiment has been generally described involving visa holders entering the United States legally, it will be appreciated that government agencies may have a valid reason to monitor other groups within the population including prison parolees, those serving home monitored sentences, known sex offenders and other populations which clearly warrant the monitoring of their activity.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that the various modifications, both as to the equipment and operating procedures, can be accomplished without departing from the scope of the invention itself.

What is claimed is:

1. A system for verifying the identify of an individual comprising:
(a) a selected central processor for collecting, storing and comparing biometric data from individual members in a first population of individuals;
(b) a portable electronic communication device associated with each of said members in said first population for communicating with said central processor wherein said communication device is configured to sense and transmit biometric data to said central processor at selected times for storage and comparison with earlier data communicated from that device;
(c) wherein said central processor includes devices to enable it to communicate back to said portable electronic communication devices.

2. A system as in claim 1 wherein said portable electronic communication devices are wireless cellular devices.

3. A system as in claim 1 wherein said biometric data includes sufficient data selected from photo, fingerprint and voice print data to achieve a desired average confidence level of positive identification of individuals in said first population.

4. A system as in claim 1 wherein each said portable electronic communication device includes components limiting communication to said central processor.

5. A system as in claim 1 wherein said central processor can determine the locations of portable electronic communication devices assigned to individuals in said first population.

6. A system as in claim 1 wherein a central processor may share data with one or more other central processors and including devices allowing a central processor to communicate with electronic devices assigned to individuals and processors belonging to a second population which is given access to stored data and comparison functions.

7. A system as in claim 6 wherein a central processor includes devices enabling it to communicate confirmation of the identity of individuals in said first population to one or more devices in said second population.

8. A system as in claim 6 wherein said central processor includes devices enabling it to communicate confirmation of the location of individuals in said first population to one or more devices in said second population.

9. A system as in claim 1 wherein said first population consists of legal alien individuals granted visas.

10. A system as in claim 2 wherein said central processor can access the location of a wireless device assigned to an individual in said first population.

11. A system as in claim 1 further including a component for encrypting data related to said individual to limit access thereto.

12. A system as in claim 8 further including a component for encrypting data related to said individual to limit access thereto.

13. A system as in claim 6 wherein said second population is selected from prospective employers, law enforcement agencies and license bureaus.

14. A method of identity verification for individuals comprising:
(a) providing at least one selected central processor for collecting, storing and comparing biometric data sent by individuals in a first population of individuals in communication therewith;
(b) providing a portable wireless electronic communication device to each individual in said first population for sensing biometric data and communicating with said at least one central processor, wherein each said communication device is configured to sense and transmit selected biometric data to said central processor for storage and comparison with later data send from said device, and to receive communications from said central processor;
(c) using said wireless electronic communication device to sense initial biometric data and transmit said data to said central processor;
(d) using said wireless electronic communication device to repeat sensing and transmission of said selected biometric data at selected intervals; and
(e) compare said later biometric data with earlier biometric data and/or with said initial biometric data to confirm or deny positive identification of an individual associated with said wireless portable electronic communication device.

15. A method as in claim 14 wherein said biometric data includes sufficient data selected from photo, fingerprint and voice print data to achieve a desired confidence level of positive identification of said individuals in said first population.

16. A method as in claim 14 including dedicating said portable wireless electronic communication devices to communicate only with said selected central processor.

17. A method as in claim 14 including identification by said central processor of the location of each electronic communication device from which a communication is received when said communication is received.

18. A method as in claim 14 further comprising the provision of a second population of communicating devices enabled to communicate with a selected central processor database and wherein said central processor verifies or denies identification of individuals in said first population to devices in said second population when requested by a communication device in said second population.

19. A method as in claim 18 wherein said biometric data includes sufficient data selected from photo, fingerprint and voice print data to achieve a desired average confidence level of accuracy in positive identification of said individuals in said first population.

20. A method as in claim 14 wherein said first population comprises alien individuals granted visas and wherein said portable electronic communication devices are cellular phones.

21. A method as in claim 14 further comprising encrypting said biometric data to each individual in said first population to limit access thereto.

22. A method as in claim 19 further comprising encrypting said biometric data to each individual in said first population to limit access thereto.

23. A method as in claim 18 further comprising limiting access of said second population of communication devices to said database.

24. A method as in claim 18 wherein said second population includes prospective employers, law enforcement agencies and licensing bureaus.

25. A method as in claim 18 including automatic communication by said selected central processor to one or more communication devices in said second population upon denial of identification of an individual in said first population.

26. A portable electronic communication device associated with a user to communicate with one or more selected central processors and dedicated to acquire and transmit biometric data of the user to a selected central processor for collecting, storing and comparing biometric data of said user and communicating results related to the identity of said user.

27. A portable electronic communication device as in claim 26 comprising a fingerprint sensor, a camera image sensor and a voice transmitter.

28. A portable electronic communication device as in claim 27 further comprising a global positioning sensor.

29. A portable electronic communication device as in claim 26 when said device is in the form of a cellular phone.

30. A portable electronic communication device as in claim 26 further comprising a GSM cellular module.

31. A portable electronic communication device as in claim 27 further comprising a global positioning sensor module, a GSM cellular module and a liquid crystal display.
